(19) United States
(12) Patent Application Publication
(10) Pub. No.: US 2014/0245235 A1
(43) Pub. Date: Aug. 28, 2014

(54) FEEDBACK METHOD AND ELECTRONIC DEVICE THEREOF

(71) Applicants: Lenovo (Beijing) Limited, Beijing (CN); Beijing Lenovo Software Ltd., Beijing (CN)

(72) Inventors: Guang Yang, Beijing (CN); Rongyao Fu, Beijing (CN)

(73) Assignees: Lenovo (Beijing) Limited, Beijing (CN); Beijing Lenovo Software Ltd., Beijing (CN)

(21) Appl. No.: 14/187,525

(22) Filed: Feb. 24, 2014

(30) Foreign Application Priority Data
Feb. 27, 2013 (CN) 201310061834.9

(51) Int. Cl. G06F 3/01

(52) U.S. Cl. CPC G06F 3/017
USPC 715/863

(57) ABSTRACT

The embodiment of the invention provides a feedback method applied to a feedback device, comprising: detecting a first operation between a first electronic device and a second electronic device; generating first information if the first operation meets a first precondition; displaying the first information which indicates that the first operation is an operation interacting between the first electronic device and the second electronic device. The feedback method and the device thereof provided by the embodiments of the invention display the operation relationships between the electronic devices to remind the user of the operation object, thereby avoids the error in the operation.

### TECHNICAL FIELD

The invention relates to the field of electronic device, in particular, to a feedback method and an electronic device thereof.

### BACKGROUND

With the development of the technique, the technique of controlling the operations of devices by a gesture and implementing interaction between electronic devices by detecting the body action of a user has come forth.

The inventor of the invention found at least the following technical defects in the prior art during the implementation of the invention.

When the user performs an interactive operation between the electronic devices by means of a gesture and the like, it cannot be determined whether the device selected by the gesture is the one the user desires to operate, and thus an error in the operation may occur.

### SUMMARY

The technical problem to be solved by the invention is to provide a feedback method and an electronic device thereof to improve the precision with which a user operates an electronic device.

In order to address the above technical problem, an embodiment of the invention provides a feedback method applied to a feedback device, comprising:

detecting a first operation between a first electronic device and a second electronic device;

generating first information if the first operation meets a first precondition; and

displaying the first information which indicates that the first operation is an operation interacting between the first electronic device and the second electronic device.

In the above method, the first information is connection information, and the connection information is displayed with one end of the connection information pointing to the first electronic device and the other end of the connection information pointing to the second electronic device.

In the above method, one end of the connection information pointing to the first electronic device and the other end of the connection information pointing to the second electronic device comprise:

collecting information on a first location of the first electronic device and a second location of the second electronic device; and

projecting the first information on a virtual interface, and superposing the virtual interface on the real scene where the first electronic device and the second electronic device are located, wherein one end of the connection information points to the first location of the first electronic device, and the other end of the connection information points to the second location of the second electronic device.

In the above method, one end of the connection information pointing to the first electronic device and the other end of the connection information pointing to the second electronic device comprise:

collecting information on a first location of the first electronic device and a second location of the second electronic device;

projecting the first information on a virtual interface, converting the second location into a second virtual location on the virtual interface, and displaying a second icon of the second electronic device at the second virtual location on the virtual interface; and

superposing the virtual interface on the real scene where the first electronic device and the second electronic device are located, wherein one end of the connection information points to the first location of the first electronic device, and the other end of the connection information points to the second icon of the second electronic device.

In the above method, one end of the connection information pointing to the first electronic device and the other end of the connection information pointing to the second electronic device comprise:

collecting information on the first electronic device and the second electronic device to generate a first scene, wherein the first scene comprises a first image or a first icon of the first electronic device and a second image or a second icon of the second electronic device; and

causing one end of the connection information to point to the first image or the first icon of the first electronic device, and the other end of the connection information to point to the second image or the second icon of the second electronic device.

In the above method, it is determined that the first operation meets a first precondition if a connection is established or information is being exchanged between the first electronic device and the second electronic device.

In the above method, generating first information comprises: generating the first information according to type of the first operation and the correspondence between operation types and information.

In the above method, detecting the first operation between the first electronic device and the second electronic device comprises:

receiving notification information from the first electronic device, wherein the notification information carries information that the first operation is performed between the first electronic device and the second electronic device.

The above method may further comprise:

after displaying the first information, stopping displaying the first information if a second operation between the first electronic device and the second electronic device is detected and the second operation meets a second precondition.

An embodiment of the invention further provides an electronic device, comprising:

a detection unit configured to detect a first operation between a first electronic device and a second electronic device;

a first information generation unit configured to determine whether the first operation meets a first precondition when the first operation is detected by the detection unit, and if so, generate first information;

a display unit configured to display the first information, wherein the first information indicates that the first operation is an operation interacting between the first electronic device and the second electronic device.

In the above electronic device, the first information displayed by the display unit is connection information, one end of the connection information pointing to the first electronic device, the other end of the connection information pointing to the second electronic device.

In the above electronic device, the electronic device may further comprise a collection unit configured to collect information on a first location of the first electronic device and a second location of the second electronic device;

wherein the display unit is further configured to project the first information on a virtual interface, and superpose the virtual interface on the real scene where the first electronic device and the second electronic device are located, wherein one end of the connection information points to the first location of the first electronic device, and the other end of the connection information points to the second location of the second electronic device.

In the above electronic device, the above electronic device may further comprise a collection unit configured to collect information on a first location of the first electronic device and a second location of the second electronic device;

wherein the display unit is further configured to project the first information on a virtual interface, convert the second location into a second virtual location on the virtual interface, display a second icon of the second electronic device at the second virtual location on the virtual interface, and superpose the virtual interface on the real scene where the first electronic device and the second electronic device are located, wherein one end of the connection information points to the first location of the first electronic device, and the other end of the connection information points to the second icon of the second electronic device.

In the above electronic device, the above electronic device may further comprise a collection unit configured to collect information on the first electronic device and the second electronic device to generate a first scene, wherein the first scene comprises a first image or a first icon of the first electronic device and a second image or a second icon of the second electronic device;

wherein the display unit is further configured to cause one end of the connection information to point to the first image or the first icon of the first electronic device, and cause the other end of the connection information to point to the second image or the second icon of the second electronic device.

In the above electronic device, the first information generation unit determines whether the first operation meets a first precondition by: determining whether a connection is established or information is being exchanged between the first electronic device and the second electronic device; and if so, determining that the first operation meets the first precondition.

In the above electronic device, the first information generation unit generates the first information by: generating the first information according to type of the first operation and the correspondence between operation types and information.

In the above electronic device, the detection unit detects the first operation between the first electronic device and the second electronic device by:

receiving notification information from the first electronic device, wherein the notification information carries information that the first operation is performed between the first electronic device and the second electronic device.

In the above electronic device, the display unit is further configured to, after displaying the first information, stop displaying the first information if the detection unit detects a second operation between the first electronic device and the second electronic device and the second operation meets a second precondition.

The feedback method and the device thereof provided by the embodiments of the invention display the operation relationships between the electronic devices so as to remind the user of the operation object, thereby avoids the error in the operation.

Other features and advantages of the invention will be set forth in the following description, which will be obvious partly from the description or be understood by embodying the invention. The object and other advantages of the invention can be implemented and obtained by the structure specially specified in the description, the claims and the figures.

### BRIEF DESCRIPTION OF THE DRAWINGS

The figures provide further understandings to the solution of the invention, and form a part of the description. They are used for explaining the solutions of the invention together with the embodiments and should not be interpreted as a limitation to the solutions of the invention.

FIG. 1 is a flow diagram of an feedback method of an embodiment of the invention;

FIG. 2 is an illustrative diagram of the first embodiment of the invention;

FIG. 3 is another illustrative diagram of the first embodiment of the invention;

FIG. 4 is another illustrative diagram of the first embodiment of the invention;

FIG. 5 is another illustrative diagram of the first embodiment of the invention;

FIG. 6 is an illustrative diagram of the second embodiment of the invention;

FIG. 7 is another illustrative diagram of the second embodiment of the invention; and

FIG. 8 is a block diagram of the electronic device of an embodiment of the invention.

### DETAILED DESCRIPTION

In order to make the objects, the solutions and the advantages of the invention more clear, the embodiments of the invention will be described in detail, in connection with the figures. It should be appreciated that the embodiments in the application and features therein can be combined arbitrarily in case no conflict occurs.

The steps illustrated in the flow diagram of the figures may be performed in computer system with, for example, a set of computer executable instruction. Furthermore, although logic orders are shown in the flow diagrams, in some cases, the illustrated or described steps may be performed by an order other than those provided herein.

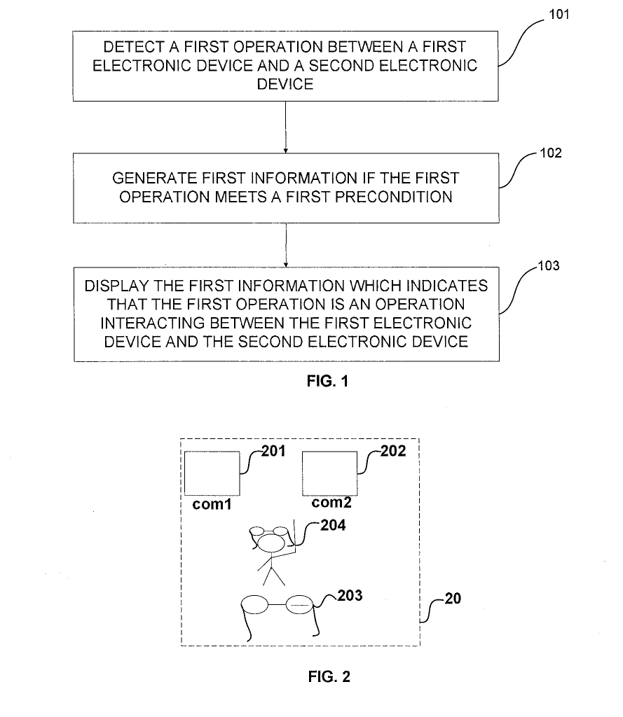

An embodiment of the invention provides a feedback method applied to a feedback device, which as shown in FIG. 1, comprises:

Step 101, detecting a first operation between a first electronic device and a second electronic device;

Step 102, generating first information if the first operation meets a first precondition;

Step 103, displaying the first information which indicates that the first operation is an operation interacting between the first electronic device and the second electronic device.

The solution of the embodiment of the invention displays the operation relationships between the electronic devices so as to remind the user of the operation object, thereby avoids the error in the operation.

In an embodiment of the invention, the feedback device is an electronic device which may be a head mounted glasses device, a helm, an intelligent terminal and the like.

The head mounted glasses device or the helm may be of:

a first type: the head mounted glasses device or the helm displays virtual information by projection. The user may see an object in the real scene directly though the head mounted glasses device or the helm. The head mounted glasses device or the helm projects the first information to the real world by a projection apparatus.

a second type: the head mounted glasses device or the helm is equipped with a glasses-type display. The head mounted glasses device or the helm scans the real scene to generate a scene image, or scans locations of respective electronic device in the real scene, replaces the respective electronic devices with icons at respective locations, and generates the scene image. After the scene image is generated, the first information is superposed on the scene image, and the scene image with the first information superposed thereon is displayed on the glasses-type display.

An intelligent terminal may implement the display of the first information by the second method above.

In an alternative of the embodiment, the first information is connection information, and the connection information is displayed with one end of the connection information pointing to the first electronic device and the other end of the connection information pointing to the second electronic device.

In an alternative of the embodiment, one end of the connection information pointing to the first electronic device and the other end of the connection information pointing to the second electronic device comprise:

collecting information on a first location of the first electronic device and a second location of the second electronic device; and

projecting the first information on a virtual interface, and superposing the virtual interface on the real scene where the first electronic device and the second electronic device are located, wherein one end of the connection information points to the first location of the first electronic device, and the other end of the connection information points to the second location of the second electronic device.

In an alternative of the embodiment, one end of the connection information pointing to the first electronic device and the other end of the connection information pointing to the second electronic device comprise:

collecting information on a first location of the first electronic device and a second location of the second electronic device;

projecting the first information on a virtual interface, converting the second location into a second virtual location on the virtual interface, and displaying a second icon of the second electronic device at the second virtual location on the virtual interface; and

superposing the virtual interface on the real scene where the first electronic device and the second electronic device are located, wherein one end of the connection information points to the first location of the first electronic device, and the other end of the connection information points to the second icon of the second electronic device.

In an alternative of the embodiment, one end of the connection information pointing to the first electronic device and the other end of the connection information pointing to the second electronic device comprise:

collecting information on the first electronic device and the second electronic device to generate a first scene, wherein the first scene comprises a first image or a first icon of the first electronic device and a second image or a second icon of the second electronic device; and

causing one end of the connection information to point to the first image or the first icon of the first electronic device, and the other end of the connection information to point to the second image or the second icon of the second electronic device.

In an alternative of the embodiment, it is determined that the first operation meets the first precondition if a connection is established or information is being exchanged between the first electronic device and the second electronic device.

In an alternative of the embodiment, generating first information comprises generating the first information according to type of the first operation and the correspondence between operation types and information. For example, when only a connection is established between the first electronic device and the second electronic device and no data is transmitted, a dashed line connecting the first electronic device and the second electronic device is generated; and when a data transmission is conducted between the first electronic device and the second electronic device, a solid line connecting the first electronic device and the second electronic device is generated. Additionally, different lines may be used to identify the transmission of different information. For example, a straight line is used in transmitting data, a wave line is used in transmitting video information, a broken line is used in transmitting audio information, and so on. The user may be reminded of the current operation type by using different prompt information.

In an alternative of the embodiment, the first operation between the first electronic device and the second electronic device is detected by:

receiving notification information from the first electronic device, wherein the notification information carries information that the first operation is performed between the first electronic device and the second electronic device.

In an alternative of the embodiment, the method further comprises: after displaying the first information, stopping displaying the first information if a second operation between the first electronic device and the second electronic device is detected and the second operation meets a second precondition. For example, a connection line is displayed when information is transmitted between the first electronic device and the second electronic device. When the information transmission is completed and the connection is discontinued, the display of the first information is stopped (i.e., stopping the display of the connection line) and the connection line disappears.

The invention will be further explained by the embodiments below.

### First Embodiment

As shown in FIG. 2, the scene 20 includes a first electronic device 201 (i.e., com1 in the figure), a second electronic device 202 (i.e., com2 in the figure), a head mounted glasses device 203 and a user 204. The first electronic device and the second electronic device may communicate with the head mounted glasses device 203 via a wireless or wired communication. The head mounted glasses device may be a standalone device which may autonomically perform information process and display, or may be combined with a background device which performs the information process and sends the information to the head mounted glasses device to display, etc.

The feedback method provided by the embodiment comprises:

Step 201, obtaining the location information of the first electronic device 201 and the second electronic device 202;

The positioning may be performed in connection with positioning techniques such as wifi and the like.

Step 202, detecting an input command from the user, such as a gesture control. An interaction is performed between the first electronic device 201 and the second electronic device 202.

Step 203, displaying a connection line according to the interaction between the first electronic device 201 and the second electronic device 202. One end of the connection line points to the first electronic device 201 and the other end of the connection line points to the second electronic device 202. Pointing to an electronic device may be that the connection line is connected directly with the electronic device or that the connection line is displayed about the electronic device rather than connected directly thereto.

In particular, steps 202 and 203 may comprise the following cases.

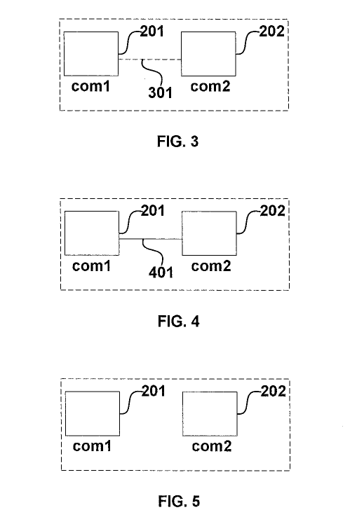

After establishing a connection with the second electronic device 202, the first electronic device 201 sends first notification information to the head mounted glasses device 203. The head mounted glasses device 203 generates a connection line 301 as shown in FIG. 3, after receiving the first notification information. The connection line 301 may be a dash line with one end connecting to the electronic device 201 and the other end connecting to the second electronic device 202. As shown in FIG. 3, which is the scene viewed by the user through the head mounted glasses device 203, the first electronic device 201 and the second electronic device 202 are tangible devices, and the connection line 301 is virtual information generated by the head mounted glasses device 203. The connection line 301 is superposed on the real scene. Finally, it presents the user a scene as shown in FIG. 3.

After a connection is established, the first electronic device 201 begins a data transmission with the second electronic device 202 and sends second notification information to the head mounted glasses device 203. The head mounted glasses device 203 generates a connection line 401 after receiving the second notification information. The connection line 401 may be a solid line with one end connecting to the electronic device 201 and the other end connecting to the second electronic device 202. As shown in FIG. 4, which is the scene viewed by the user through the head mounted glasses device 203, the first electronic device 201 and the second electronic device 202 are tangible devices, and the connection line 401 is virtual information generated by the head mounted glasses device 203. The connection line 401 is superposed on the real scene. Finally, it presents the user a scene as shown in FIG. 4.

After completing its data transmission with the second electronic device 202, the first electronic device 201 sends third notification information to the head mounted glasses device 203. The head mounted glasses device 203 does not display the connection line 401 after receiving the third notification information. As shown in FIG. 5, which is the scene viewed by the user through the head mounted glasses device 203, there are only the first electronic device 201 and the second electronic device 202 and no virtual information is presented.

The connection lines provided in FIGS. 3 and 4 are used for illustrating, and other kinds of connection lines are also available. For example, different colors may be used for the differentiation purpose, or other patterns can be used, or the connection line may include two segments, one connecting to the first electronic device 201 and the other connecting to the second electronic device 202. The two segments are indicated as being connected with each other by a marker. For example, the two segments both carry the same sign (a number or an icon). Additionally, the type of the current operation may be indicated by literal information on the connection line. For example, the literal information is displayed on the connection line when the data is being transmitted, indicating that the data is currently being transmitted.

### Second Embodiment

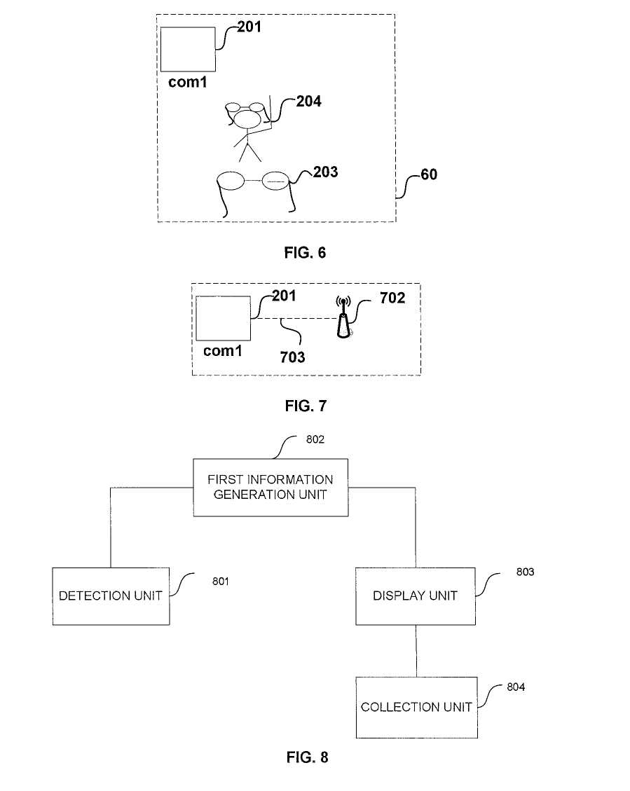

As shown in FIG. 6, the scene 60 includes a first electronic device 201 (i.e. com1 in the figure), a head mounted glasses device 203 and a user 204. The first electronic device 201 may communicate with the head mounted glasses device 203 via a wireless or wired communication.

The first electronic device 201 establishes a wireless connection, such as a 3G or wifi connection, and notifies it to the head mounted glasses device 203. The head mounted glasses device 203 generates a virtual icon 702 for the 3G or wifi access device and a connection line 703 connecting the first electronic device 201 with the virtual icon 702. As shown in FIG. 7, which is the scene viewed by the user through the head mounted glasses device 203, the first electronic device 201 is a tangible device, the icon 702 is virtual information generated by the head mounted glasses device 203 for representing the 3G or wifi access device, and the connection line 703 is virtual information generated by the head mounted glasses device 203. The icon 702 and the connection line 703 are superposed on the real scene. Finally, it presents the user a scene as shown in FIG. 7.

When the first electronic device 201 downloads data from or uploads data to a network, the connection line between the first electronic device and the virtual icon 702 may become a solid line.

An embodiment of the invention further provides an electronic device, as shown in FIG. 8, comprising: the electronic device comprises a detection unit 801, a first information generation unit 802 and a display unit 803, wherein:

the detection unit 801 is configured to detect a first operation between a first electronic device and a second electronic device or not;

the first information generation unit 802 is configured to determine whether the first operation meets a first precondition when the first operation is detected by the detection unit 801, and if so, generate first information;

the display unit 803 is configured to display the first information, wherein the first information indicates that the first operation is an operation interacting between the first electronic device and the second electronic device.

In an alternative of the embodiment, the first information displayed by the display unit 803 is connection information, one end of the connection information pointing to the first electronic device, the other end of the connection information pointing to the second electronic device.

In an alternative of the embodiment, the electronic device further comprises a collection unit 804 configured to collect information on a first location of the first electronic device and a second location of the second electronic device;

wherein the display unit 803 is further configured to project the first information on a virtual interface, and superpose the virtual interface on the real scene where the first electronic device and the second electronic device are located, wherein one end of the connection information points to the first location of the first electronic device, and the other end of the connection information points to the second location of the second electronic device.

In an alternative of the embodiment, the electronic device further comprises:

a collection unit 804 configured to collect information on a first location of the first electronic device and a second location of the second electronic device;

wherein the display unit 803 is further configured to project the first information on a virtual interface, convert the second location into a second virtual location on the virtual interface, display a second icon of the second electronic device at the second virtual location on the virtual interface, and superpose the virtual interface on the real scene where the first electronic device and the second electronic device are located, wherein one end of the connection information points to the first location of the first electronic device, and the other end of the connection information points to the second icon of the second electronic device.

In an alternative of the embodiment, the electronic device further comprises:

a collection unit 804 configured to collect information on the first electronic device and the second electronic device to generate a first scene, wherein the first scene comprises a first image or a first icon of the first electronic device and a second image or a second icon of the second electronic device;

wherein the display unit 803 is further configured to cause one end of the connection information to point to the first image or the first icon of the first electronic device, and cause the other end of the connection information to point to the second image or the second icon of the second electronic device.

In an alternative of the embodiment, the first information generation unit 802 determines whether the first operation meets a first precondition by: determining whether a connection is established or information is being exchanged between the first electronic device and the second electronic device; and if so, determining that the first operation meets the first precondition.

In an alternative of the embodiment, the first information generation unit 802 generate first information by: generating the first information according to the type of the first operation and the correspondence between operation types and information.

In an alternative of the embodiment, the detection unit 801 detects the first operation between the first electronic device and the second electronic device by:

receiving notification information from the first electronic device, wherein the notification information carries information that the first operation is performed between the first electronic device and the second electronic device.

In an alternative of the embodiment, after displaying the first information, the display unit 803 is further configured to stop displaying the first information if the detection unit 801 detects a second operation between the first electronic device and the second electronic device and the second operation meets a second precondition.

It should be appreciated that many details stated in the method embodiment also apply to the electronic device embodiment, and thus the repeated descriptions about the same or similar portions are omitted.

One with ordinary skills in the art should understand that the above components of the apparatus and steps in the method provided by the embodiments of the application may be centralized in a single computing apparatus, or distributed over a network formed by a plurality of computing apparatus. Optionally, they may be implemented by the program codes executable by the computing apparatus, or they may be manufactured into integrate circuit modules, or more than one modules and steps therein may be manufactured into a single integrate circuit module. As such, the invention is not limited to any specific combination of hardware and software.

Though the implementation of the invention has been disclosed as above, the disclosed content is only the implementation introduced for the purpose of understanding the invention, rather than limiting the invention. Anyone with ordinary skills in the art of the invention can make any modifications and changes to the forms and the details of the implementation without departing from the spirit and scope as disclosed by the invention. The patent protection scope of the invention, however, is defined by the appended claims.

1. A feedback method applied to a feedback device, comprising:
detecting a first operation between a first electronic device and a second electronic device;
generating first information if the first operation meets a first precondition; and
displaying the first information which indicates that the first operation is an operation interacting between the first electronic device and the second electronic device.

2. The method of claim 1, wherein the first information is connection information;
wherein the connection information is displayed with one end of the connection information pointing to the first electronic device and the other end of the connection information pointing to the second electronic device.

3. The method of claim 2, wherein one end of the connection information pointing to the first electronic device and the other end of the connection information pointing to the second electronic device comprise:
collecting information on a first location of the first electronic device and a second location of the second electronic device; and
projecting the first information on a virtual interface, and superposing the virtual interface on the real scene where the first electronic device and the second electronic device are located, wherein one end of the connection information points to the first location of the first electronic device, and the other end of the connection information points to the second location of the second electronic device.

4. The method of claim 2, wherein one end of the connection information pointing to the first electronic device and the other end of the connection information pointing to the second electronic device comprise:
collecting information on a first location of the first electronic device and a second location of the second electronic device;
projecting the first information on a virtual interface, converting the second location into a second virtual location on the virtual interface, and displaying a second icon of the second electronic device at the second virtual location on the virtual interface; and
superposing the virtual interface on the real scene where the first electronic device and the second electronic device are located, wherein one end of the connection information points to the first location of the first electronic device, and the other end of the connection information points to the second icon of the second electronic device.

5. The method of claim 2, wherein one end of the connection information pointing to the first electronic device and the other end of the connection information pointing to the second electronic device comprise:
collecting information on the first electronic device and the second electronic device to generate a first scene, wherein the first scene comprises a first image or a first icon of the first electronic device and a second image or a second icon of the second electronic device; and
causing one end of the connection information to point to the first image or the first icon of the first electronic device, and the other end of the connection information to point to the second image or the second icon of the second electronic device.

6. The method of claim 1, wherein it is determined that the first operation meets a first precondition if a connection is established or information is being exchanged between the first electronic device and the second electronic device.

7. The method of claim 1, wherein generating the first information comprises:
generating the first information according to type of the first operation and the correspondence between operation types and information.

8. The method of claim 1, wherein detecting the first operation between the first electronic device and the second electronic device comprises:
receiving notification information from the first electronic device, wherein the notification information carries information that the first operation is performed between the first electronic device and the second electronic device.

9. The method of claim 1, further comprising:
after displaying the first information, stopping displaying the first information if a second operation between the first electronic device and the second electronic device is detected and the second operation meets a second precondition.

10. An electronic device, comprising:
a detection unit configured to detect a first operation between a first electronic device and a second electronic device;
a first information generation unit configured to determine whether the first operation meets a first precondition when the first operation is detected by the detection unit, and if so, generate first information;
a display unit configured to display the first information, wherein the first information indicates that the first operation is an operation interacting between the first electronic device and the second electronic device.

11. The electronic device of claim 10, wherein
the first information displayed by the display unit is connection information, one end of the connection information pointing to the first electronic device, the other end of the connection information pointing to the second electronic device.

12. The electronic device of claim 11, further comprising:
a collection unit configured to collect information on a first location of the first electronic device and a second location of the second electronic device;
wherein the display unit is further configured to project the first information on a virtual interface, and superpose the virtual interface on the real scene where the first electronic device and the second electronic device are located, wherein one end of the connection information points to the first location of the first electronic device, and the other end of the connection information points to the second location of the second electronic device.

13. The electronic device of claim 11, further comprising:
a collection unit configured to collect information on a first location of the first electronic device and a second location of the second electronic device;
wherein the display unit is further configured to project the first information on a virtual interface, convert the second location into a second virtual location on the virtual interface, display a second icon of the second electronic device at the second virtual location on the virtual interface, and superpose the virtual interface on the real scene where the first electronic device and the second electronic device are located, wherein one end of the connection information points to the first location of the first electronic device, and the other end of the connection information points to the second icon of the second electronic device.

14. The electronic device of claim 11, further comprising:
a collection unit configured to collect information on the first electronic device and the second electronic device to generate a first scene, wherein the first scene comprises a first image or a first icon of the first electronic device and a second image or a second icon of the second electronic device;
wherein the display unit is further configured to cause one end of the connection information to point to the first image or the first icon of the first electronic device, and cause the other end of the connection information to point to the second image or the second icon of the second electronic device.

15. The electronic device of claim 10, wherein the first information generation unit determines whether the first operation meets a first precondition by:
determining whether a connection is established or information is being exchanged between the first electronic device and the second electronic device; and if so, determining that the first operation meets the first precondition.

16. The electronic device of claim 10, wherein the first information generation unit generates first information by:
generating the first information according to type of the first operation and the correspondence between operation types and information.

17. The electronic device of claim 10, wherein the detection unit detects the first operation between the first electronic device and the second electronic device by:
receiving notification information from the first electronic device, wherein the notification information carries information that the first operation is performed between the first electronic device and the second electronic device.

18. The electronic device of claim 10, wherein the display unit is further configured to, after displaying the first information, stop displaying the first information if the detection unit detects a second operation between the first electronic device and the second electronic device and the second operation meets a second precondition.
